(19) United States
(12) Patent Application Publication
(10) Pub. No.: US 2017/0010012 A1
(43) Pub. Date: Jan. 12, 2017

(54) VENTILATING SYSTEM AND CONTROL UNIT THEREOF

(71) Applicant: BIGBEST SOLUTIONS, INC., Taichung City (TW)

(72) Inventors: Shih-Ping HO, Taichung City (TW); Hsin-Liang WANG, Taichung City (TW); Kuan-Ming WANG, Taichung City (TW)

(73) Assignee: BIGBEST SOLUTIONS, INC., Taichung City (TW)

(21) Appl. No.: 15/200,583

(22) Filed: Jul. 1, 2016

(30) Foreign Application Priority Data
Jul. 6, 2015 (TW) 104121850

(51) Int. Cl. F24F 11/00; G05B 15/02; F04D 27/00

(52) U.S. Cl. CPC F24F 11/0001; F04D 27/004; F24F 11/0086; G05B 15/02

(57) ABSTRACT

A ventilating system includes: an electric fan including a fan motor and a fan impeller; and a control unit including a storage module storing a lookup table, a power detection circuit and a control circuit. The power detection circuit detects a power signal received by the ventilating system so as to generate a power detection signal. The control circuit generates and outputs a motor control signal associated with a target rotational speed based on an airflow input signal associated with a desired airflow volume and on the power detection signal and with reference to the lookup table. The fan motor drives the fan impeller in response to the motor control signal, so that the electric fan produces the desired airflow volume.

### CROSS-REFERENCE TO RELATED APPLICATION

This application claims priority of Taiwanese Patent Application No. 104121850, filed on Jul. 6, 2015.

### FIELD

The disclosure relates to a ventilating system and a control unit thereof.

### BACKGROUND

A conventional ventilating system includes a detection unit, a motor control unit, a fan impeller and a fan motor having a drive shaft.

The fan motor is coupled to and controlled by the motor control unit. The fan impeller is connected axially to the drive shaft of the fan motor. The detection unit is used to detect a current rotational speed and a corresponding required electric current of the fan motor so as to generate a current power consumed by the fan motor. The motor control unit is coupled to the detection unit. The motor control unit is operable to generate, based on an airflow input signal associated with a desired airflow and on the current power, a motor control signal associated with a target rotational speed of the drive shaft, and to output the motor control signal to the fan motor. Accordingly, the fan motor drives the fan impeller in response to the motor control signal to rotate together with the drive shaft at the target rotational speed, so that the fan impeller produces the desired airflow.

In the conventional ventilating system, the fan motor is usually a DC motor that is controlled by the motor control unit. The detection unit, the motor control unit and the fan motor may be integrated into a single module. Therefore, for DC motors of different specifications, differently designed single modules corresponding thereto are required. In addition, the detection unit will use relatively complicated circuit configuration and method to detect the current rotational speed and the required electric current of the fan motor. Thus, there is still room for improvement on the conventional ventilating system.

### SUMMARY

Therefore, an object of the disclosure is to provide a control unit and a ventilating system that can alleviate the drawbacks of the prior art.

According to one aspect of the disclosure, a ventilating system includes an electric fan and a control unit.

The electric fan includes a fan motor and a fan impeller.

The fan motor has a drive shaft.

The fan impeller is connected axially to the drive shaft of the fan motor and is driven by the fan motor to rotate.

The control unit includes a storage module, a power detection circuit and a control circuit.

The storage module stores a lookup table. The lookup table includes relationship information among a rotational speed of the drive shaft of the fan motor, an airflow volume produced by the electric fan and power to be supplied to the ventilating system.

The power detection circuit is configured to detect a power signal received by the ventilating system so as to generate a power detection signal that indicates current power supplied to the ventilating system.

The control circuit is coupled to the fan motor, the storage module and the power detection circuit, and receives the power detection signal from the power detection circuit. The control circuit is configured to generate, based on an airflow input signal associated with a desired airflow volume and on the power detection signal and with reference to the lookup table, a motor control signal associated with a target rotational speed of the drive shaft, and outputs the motor control signal to the fan motor.

The fan motor drives the fan impeller in response to the motor control signal from the control circuit to rotate together with the drive shaft at the target rotational speed, so that the electric fan produces the desired airflow volume.

According to another aspect of the disclosure, there is provided a control unit for controlling an electric fan of a ventilating system to produce a desired airflow volume. The electric fan includes a fan motor that has a drive shaft provided axially with a fan impeller. The control unit includes a storage module, a power detection circuit and a control circuit.

The storage module stores a lookup table. The lookup table includes relationship information among a rotational speed of the drive shaft of the fan motor, an airflow volume produced by the electric fan and power to be supplied to the ventilating system.

The power detection circuit is configured to detect a power signal received by the ventilating system so as to generate a power detection signal that indicates current power supplied to the ventilating system.

The control circuit is coupled to the storage module and the power detection circuit, and receives the power detection signal from the power detection circuit. The control circuit is configured to generate, based on an airflow input signal associated with the desired airflow volume and on the power detection signal and with reference to the lookup table, a motor control signal associated with a target rotational speed of the drive shaft of the fan motor, and outputs the motor control signal to the fan motor to control the fan motor to drive the fan impeller to rotate together with the drive shaft at the target rotational speed, so that the electric fan produces the desired airflow volume.

### BRIEF DESCRIPTION OF THE DRAWINGS

Other features and advantages of the disclosure will become apparent in the following detailed description of the embodiment with reference to the accompanying drawings, of which:

FIG. 1 is a schematic electrical block diagram illustrating an embodiment of a ventilating system according to the disclosure; and

FIG. 2 is a simulation plot illustrating exemplary relationship among pressure, airflow volume and rotational speed according to the disclosure.

### DETAILED DESCRIPTION

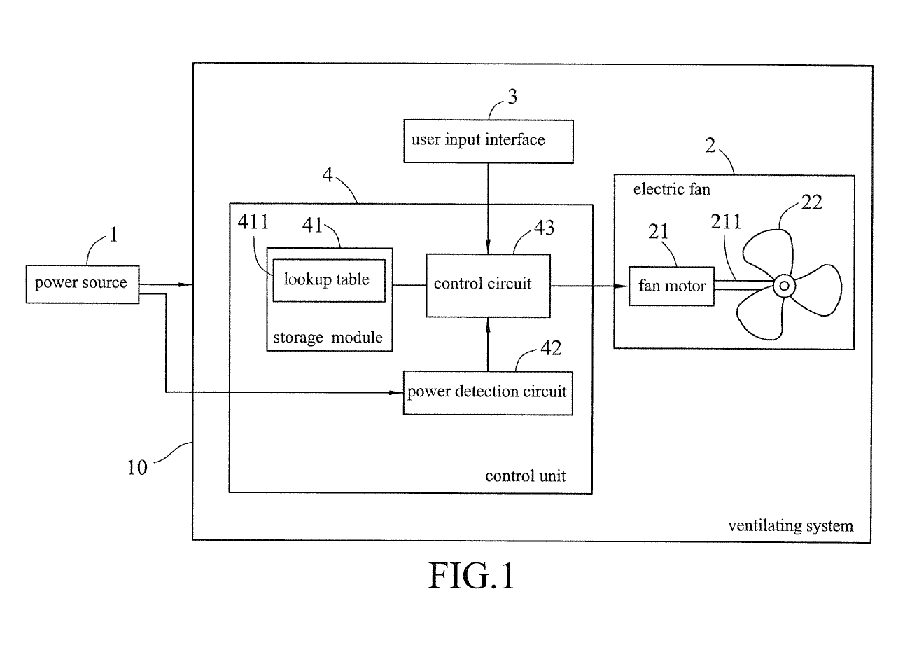

Referring to FIG. 1, one embodiment of a ventilating system 10 according to the disclosure is adapted for receiving a power signal from a power source 1. The ventilating system 10 includes an electric fan 2, a user input interface 3 and a control unit 4.

The electric fan 2 includes a fan motor 21 having a drive shaft 211, and a fan impeller 22. The fan impeller 22 is connected axially to the drive shaft 211 of the fan motor 21 and is driven by the fan motor 21 to rotate.

The user input interface 3 is configured to generate an airflow input signal through a manual input operation corresponding to a desired airflow volume.

The control unit 4 is coupled to the electric fan 2 and the user input interface 3, and receives the airflow input signal from the user input interface 3. The control unit 4 includes a storage module 41, a power detection circuit 42 and a control circuit 43.

The storage module 41 stores a lookup table 411. The lookup table 411 includes relationship information among a rotational speed of the drive shaft 211 of the fan motor 21, a volume of an airflow produced by the electric fan 2 and power to be supplied to the ventilating system 10.

The power detection circuit 42 is configured to detect the power signal received by the ventilating system 10 so as to generate a power detection signal that indicates current power supplied to the ventilating system 10. The control circuit 43 is coupled to the fan motor 21, the storage module 41 and the power detection circuit 42, and receives the power detection signal from the power detection circuit 42. The control circuit 43 is configured to generate, based on the airflow input signal associated with the desired airflow volume and on the power detection signal and with reference to the lookup table 411, a motor control signal associated with a target rotational speed of the drive shaft 211, and outputs the motor control signal to the fan motor 21. The fan motor 21 drives the fan impeller 22 in response to the motor control signal from the control circuit 43 to rotate together with the drive shaft 211 at the target rotational speed, so that the electric fan 2 produces airflow with the desired airflow volume.

It is noted that, in this embodiment, the storage module 41, the power detection circuit 42 and the control circuit 43 may be, for example, integrated into a single universal control board. The fan motor 21 is, but not limited to, a brushless DC motor including a driver (not shown). The driver may drive the fan impeller 22 in response to the motor control signal from the control circuit 43 to rotate together with the drive shaft 211 at the target rotational speed. In other embodiments, the fan motor 21 is, for example, an AC motor including a frequency converter (not shown). The frequency converter may drive the fan impeller 22 in response to the motor control signal from the control circuit 43 to rotate at the target rotational speed.

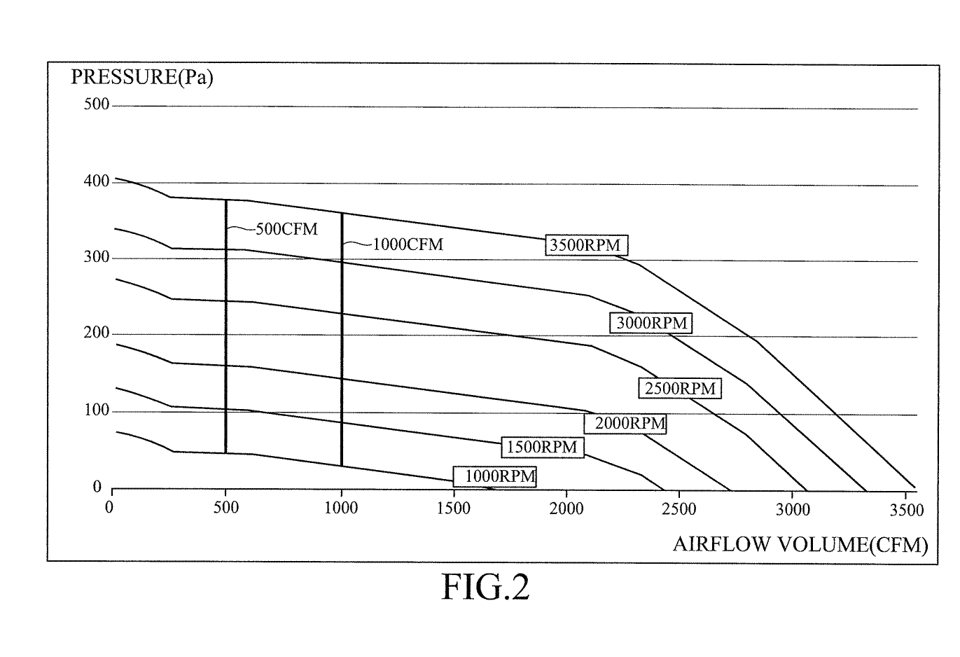

FIG. 2 illustrates exemplary simulation results of pressure versus airflow volume according to the embodiment. From the exemplary simulation results of FIG. 2, under various ambient pressures, the ventilating system 10 needs various rotational speeds to produce the same airflow volume.

In this embodiment, the relationship information of the lookup table 411 includes a plurality of data groups, each of which includes an airflow volume value, a pressure value, a power value and a rotational speed value. Table 1 is an example listing twelve data groups of the relationship information for the lookup table 411 according to FIG. 2. The 1^{st} to 6^{th} data groups correspond to a specific airflow volume value (i.e., 500 CFM), and the 7^{th} to 12^{th} data groups correspond to a different specific airflow volume value (i.e., 1000 CFM).

TABLE 1

| | 1^{st} data | 2^{nd} data | 3^{rd} data | 4^{th} data | 5^{th} data | 6^{th} data |
|---|---|---|---|---|---|---|
| | group | group | group | group | group | group |
| airflow | 500 | 500 | 500 | 500 | 500 | 500 |
| volume | | | | | | |
| value | | | | | | |
| (CFM) | | | | | | |
| pressure | 57 | 107 | 161 | 255 | 312 | 386 |
| value | | | | | | |
| (Pa) | | | | | | |
| power | 261 | 320 | 412 | 433 | 493 | 525 |
| value | | | | | | |
| (W) | | | | | | |
| rotational | 1000 | 1500 | 2000 | 2500 | 3000 | 3500 |
| speed | | | | | | |
| value | | | | | | |
| (RPM) | | | | | | |
| | 7^{th} | 8^{th} | 9^{th} | 10^{th} | 11^{th} | 12^{th} |
| | data | data | data | data | data | data |
| | group | group | group | group | group | group |
| airflow | 1000 | 1000 | 1000 | 1000 | 1000 | 1000 |
| volume | | | | | | |
| value | | | | | | |
| (CFM) | | | | | | |
| pressure | 47 | 90 | 151 | 245 | 298 | 356 |
| value | | | | | | |
| (Pa) | | | | | | |
| power | 273 | 341 | 445 | 475 | 521 | 584 |
| value | | | | | | |
| (W) | | | | | | |
| rotational | 1000 | 1500 | 2000 | 2500 | 3000 | 3500 |
| speed | | | | | | |
| value | | | | | | |
| (RPM) | | | | | | |

The control circuit 43 selects from the data groups of the lookup table 411 a matching data group, the power value and the airflow volume value of which are similar or identical respectively to the current power and the desired airflow volume. The rotational speed value of the matching data group serves as the target rotational speed. In one embodiment, the control circuit 43 selects one of the data groups, whose airflow volume value is equal to the desired airflow volume indicated by the airflow input signal and whose power value is closest to, in comparison with those of other data groups, but not greater than the current power indicated by the power detection signal, to be the matching data group. For example, when the desired airflow volume indicated by the airflow input signal is 1000 CFM, the control circuit 43 first looks at the first data group in the lookup table 411 whose airflow volume value is 1000 CFM (i.e., the 7^{th} data group), and determines whether the current power indicated by the power detection signal is smaller than the power value (i.e., 273 W) of the 7^{th} data group. If not, the 7^{th} data group serves as the matching data group and the rotational speed of 1000 RPM thereof is taken to be the target rotational speed value; otherwise, the control circuit 43 looks at a second data group in the lookup table 411 whose the airflow volume value is 1000 CFM (i.e., the 8^{th} data group). The control circuit 43 determines whether the current power is smaller than the power value (i.e., 341 W) of the 8^{th} data group. If not, the 8^{th} data group serves as the matching data group and the rotational speed of 1500 RPM thereof is taken to be the target rotational speed value; otherwise, the control circuit 43 looks at a third data group whose the airflow volume value is 1000 CFM (i.e., the 9^{th} data group). The control circuit 43 determines whether the current power is smaller than the power value (i.e., 341 W) of the 9^{th} data group. If not, the 9^{th} data group serves as the matching data group and the rotational speed of 2000 RPM thereof is taken to be the target rotational speed value; otherwise, the control circuit 43 goes through a subsequent data group with the same airflow volume value, and so on and so forth.

To sum up, the control unit 4 and the electric fan 2 of this disclosure are designed to be two separate components. The control unit 4 can be used to control different AC motors or different DC motors. Therefore, if the fan motor 21 of the ventilating system 10 is replaced by a new motor with different specifications from the fan motor 21, the same control unit 4 can still control the new motor without the need for redesigning the single module in the conventional ventilating system. In addition, the ventilating system 10 of this disclosure determines the target rotational speed of the drive shaft 211 based on the power detection signal from the power detection circuit 42 and on the airflow input signal associated with the desired airflow volume, and with reference to the lookup table 411, and the complex detection unit required in the prior art can be omitted. Accordingly, the ventilating system 10 has a relatively simple circuit configuration as compared to the aforementioned conventional ventilating system.

While the disclosure has been described in connection with what is considered the exemplary embodiment, it is understood that this disclosure is not limited to the disclosed embodiment but is intended to cover various arrangements included within the spirit and scope of the broadest interpretation so as to encompass all such modifications and equivalent arrangements.

What is claimed is:

1. A ventilating system comprising:
an electric fan including
a fan motor having a drive shaft, and
a fan impeller connected axially to said drive shaft of said fan motor and driven by said fan motor to rotate; and
a control unit including
a storage module storing a lookup table, said lookup table including relationship information among a rotational speed of said drive shaft of said fan motor, an airflow volume produced by said electric fan and power to be supplied to said ventilating system,
a power detection circuit configured to detect a power signal received by said ventilating system so as to generate a power detection signal that indicates current power supplied to said ventilating system, and
a control circuit coupled to said fan motor, said storage module and said power detection circuit, said control circuit receiving the power detection signal from said power detection circuit, being configured to generate, based on an airflow input signal associated with a desired airflow volume and on the power detection signal and with reference to said lookup table, a motor control signal associated with a target rotational speed of said drive shaft, and outputting the motor control signal to said fan motor;
wherein said fan motor drives said fan impeller in response to the motor control signal from said control circuit to rotate together with said drive shaft at the target rotational speed, so that said electric fan produces the desired airflow volume.

2. The ventilating system of claim 1, wherein:
the relationship information includes a plurality of data groups, each of which includes a rotational speed value, an airflow volume value and a power value;
said control circuit selects from the data groups a matching data group, the power value and the airflow volume value of which are similar or identical respectively to the current power and the desired airflow, and the rotational speed value of which is taken to be the target rotational speed.

3. The ventilating system of claim 1, further comprising:
a user input interface coupled to said control circuit, said user input interface being configured to generate the airflow input signal through a manual input operation corresponding to the desired airflow volume, and to output the airflow input signal to said control circuit.

4. A control unit for controlling an electric fan of a ventilating system to produce a desired airflow volume, the electric fan including a fan motor that has a drive shaft provided axially with a fan impeller, said control unit comprising:
a storage module storing a lookup table, said lookup table including relationship information among a rotational speed of the drive shaft of the fan motor, an airflow volume produced by the electric fan and power to be supplied to the ventilating system;
a power detection circuit configured to detect a power signal received by the ventilating system so as to generate a power detection signal that indicates current power supplied to the ventilating system; and
a control circuit coupled to said storage module and said power detection circuit, said control circuit receiving the power detection signal from said power detection circuit, being configured to generate, based on an airflow input signal associated with the desired airflow and on the power detection signal and with reference to said lookup table, a motor control signal associated with a target rotational speed of the drive shaft of the fan motor, and outputting the motor control signal to the fan motor to control the fan motor to drive the fan impeller to rotate together with the drive shaft at the target rotational speed, so that the electric fan produces the desired airflow.

5. The control unit of claim 4, wherein:
the relationship information includes a plurality of data groups, each of which includes a rotational speed value, an airflow volume value and a power value;
said control circuit selects from the data groups a matching data group, the power value and the airflow volume value of which are similar or identical respectively to the current power and the desired airflow volume, and the rotational speed value of which is taken to be the target rotational speed.
